(19) United States
(12) Patent Application Publication
(10) Pub. No.: US 2011/0031230 A1
(43) Pub. Date: Feb. 10, 2011

(54) BUILT-IN HEATING DEVICE IN MATTRESS

(76) Inventor: Hyeong Seub KIM, Busan (KR)

Correspondence Address: BIRCH STEWART KOLASCH & BIRCH, PO BOX 747, FALLS CHURCH, VA, 22040-0747, US

(21) Appl. No.: 12/621,297

(22) Filed: Nov. 18, 2009

(30) Foreign Application Priority Data
Aug. 7, 2009 (KR) 20-2009-0010325

(51) Int. Cl. H05B 3/20; A47C 21/04

(52) U.S. Cl. 219/217; 5/694

(57) ABSTRACT

A built-in heating device for a bed mattress including a base plate, a heater coupled with an upper surface of the base plate such that the heater is spaced apart from the base plate, a side member formed along an upper edge of the base plate without coming into contact with the heater, and a net-type protection cover coupled with an upper portion of the side member, wherein a plurality of support members is coupled to an upper portion of a side of the side member while being bent into the shape of [symbol] as seen in a side view and separated from the upper surface of the protection cover, so as to, when the heating device is installed between bed springs in the bed mattress and pressure is applied onto the upper surface of the protection cover, prevent the protection cover from being damaged.

### BACKGROUND OF THE INVENTION

1. Field of the Invention

The present invention relates, in general, to a built-in heating device adapted to a bed mattress and, more particularly, to a built-in heating device particularly built between bed springs in a bed mattress, which cannot be broken even when a user lies on the mattress.

2. Description of the Related Art

Generally, a bed comprises a frame and a mattress installed on the upper surface of the frame. Recently, a heating function has been added to such a bed.

While most mattresses contain a plurality of springs for a soft, cushiony effect, it is inconvenient to use in for example cold weather because the mattress itself does not generate heat. Moreover, in the case of Korean people, who are familiar with living in winter with the Korean ondol, i.e. a hot-floor, they would use an electric blanket or the like on the mattress.

As a more advanced version, a spring type mattress with a built-in heating device was proposed, a type of which representatively comprises a conductive type, wherein a hot wire is installed between an upper portion of the spring and a sheet cover, a water-circulation type, wherein a water pipe is installed in order to circulate warm water, or an air-circulation type, wherein a heater is installed so as to circulate warm air.

FIG. 1 illustrates an example of a built-in heating device in a mattress according to the prior art, the construction of which comprises a base plate 10, a heater 20 coupled with an upper surface of the base plate 10 such that the heater 20 is spaced apart from the base plate 10, a side member 30 formed along an upper edge of the base plate 10 without coming into contact with the heater 20, and a net-type protection cover 40 coupled with an upper portion of the side member 30 (the base plate and the heater were illustrated in FIG. 7).

Such a heating device is built in a conventional bed mattress which comprises a plurality of bed springs s and a wire w connected between the bed springs s (see FIG. 7).

In case the heating device of FIG. 1 is constructed in the conventional bed mattress, for example when a user lies on the mattress, the heating device is problematically damaged owing to the pressure applied downwards from the upper portion of the mattress.

In order to solve the problem, as illustrated in FIG. 2, Korean Utility Model Registration No. 20-0438179 entitled “A BUILT-IN HEATER IN A MATTRESS AND INSTALLATION STRUCTURE THEREOF” was proposed in which a support structure F as a casing structure comprising the above heating device is provided.

The support structure F is elastically movable in a vertical direction, and a supporting net is coupled to an upper portion of it to support the upper surface of the mattress, thereby protecting the heating device from the pressure from the upper surface of the mattress.

However, in the case of the support structure F, it needs additional space outside the existing heating device, which makes the mattress require a wider installation space on the inside.

### SUMMARY OF THE INVENTION

Accordingly, the present invention has been made keeping in mind the above problems occurring in the related art, and the present invention is intended to propose a built-in heating device particularly built between bed springs in a bed mattress, which cannot be broken even when a user lies on the mattress.

In order to achieve the above object, according to one aspect of the present invention, there is provided a built-in heating device for a bed mattress which includes: a base plate; a heater coupled with an upper surface of the base plate such that the heater is spaced apart from the base plate; a side member formed along an upper edge of the base plate without coming into contact with the heater; and a net-type protection cover coupled with an upper portion of the side member, wherein a plurality of support members is coupled to an upper portion of a side of the side member while being bent into the shape of a [symbol] in a side view and separated from the upper surface of the protection cover, so as to, when the heating device is installed between bed springs in the bed mattress and pressure is applied onto the upper surface of the protection cover, prevent the protection cover from being damaged.

The support member may be a [symbol] type planar member having a plurality of holes.

The support member may include two [symbol] type bent shafts with two bent ends connected with each other, and a stop ring may be further provided between the support member and the upper portion the side of the side member for firm coupling.

One or more hooks may be provided on an undersurface of the base plate in order to, when the heating device is fixedly installed on the base of the mattress, engage the base plate using a C-ring.

A plurality of tensioners may be provided such that one set of ends thereof is installed on both sides of the heating device, and the other set of ends thereof is engaged with a wire or a bed spring, which is provided on the base plate of the mattress, so as to stably support the heating device.

According to the built-in heating device for a bed mattress, the protection cover cannot be prevented from being damaged when a user lies on the mattress or pressure is applied onto the mattress, without using a separate and wider space or the support structure.

Further, tensioners are provided such that one set of ends thereof is installed on both sides of the heating device, and the other set of ends thereof is engaged with a wire or a bed spring, which is provided on the base plate of the mattress, so that the heating device can be stably supported.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a view illustrating a built-in heating device for a bed mattress according to the prior art;

FIG. 2 is a view illustrating the installation structure of the built-in heating device for a bed mattress according to the prior art;

FIG. 3 is a view illustrating a built-in heating device for a bed mattress according to an embodiment of the present invention;

FIG. 4 is a view illustrating a built-in heating device for a bed mattress according to another embodiment of the present invention;

FIGS. 5A to 5C are views illustrating various kinds of support members which are provided in the heating device;

FIG. 6 is a perspective view illustrating an undersurface of a base plate of the heating device; and

FIG. 7 is a view illustrating the installation structure of the built-in heating device for a bed mattress according to the present invention.

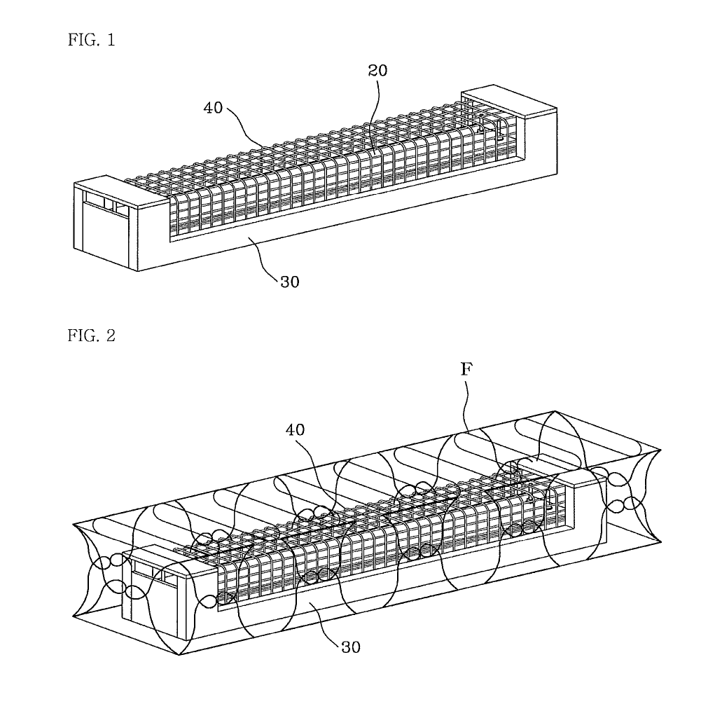

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts. In describing the present invention, if the detailed description on the related art or construction is determined to make the gist of the present invention ambiguous, the detailed description will be omitted. Further, if descriptions on the relations between constitutional elements overlap each other, the overlapping description will also be omitted.

The present invention relates to a built-in heating device adapted to a bed mattress and, more particularly, to a built-in heating device which is built particularly between the bed springs of a bed mattress, and which cannot be broken or damaged even when a user lies on the mattress or pressure is applied onto the mattress.

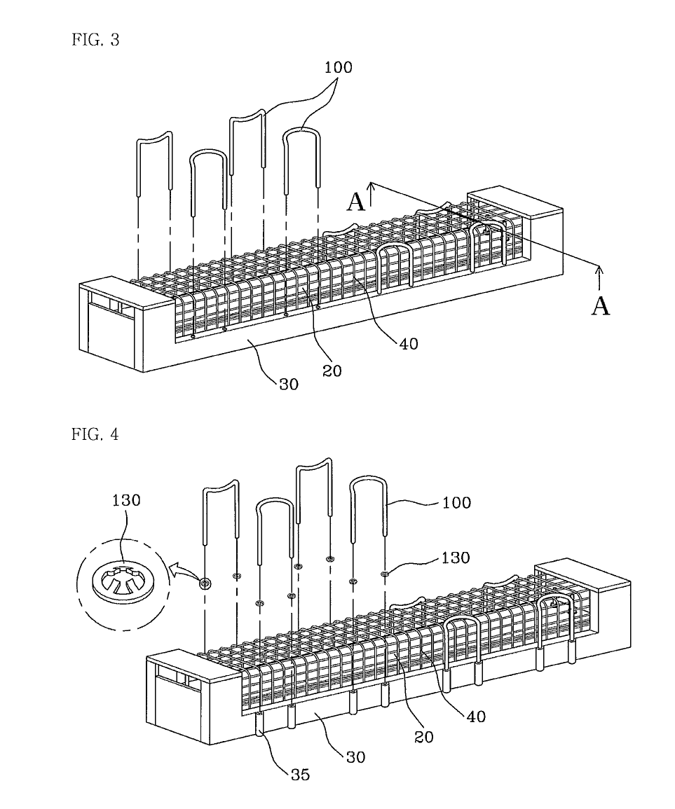

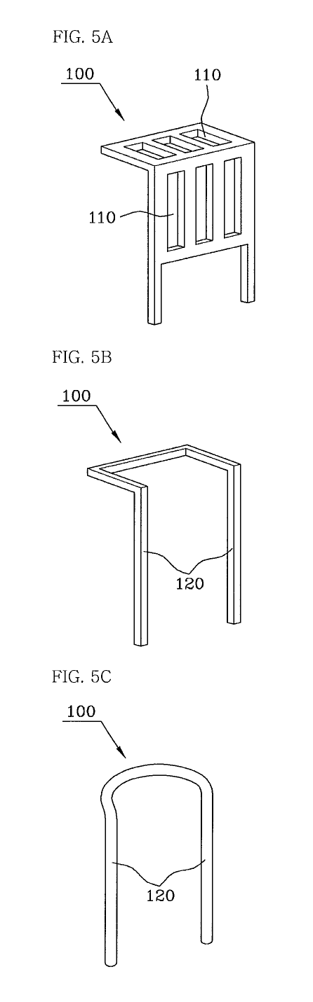

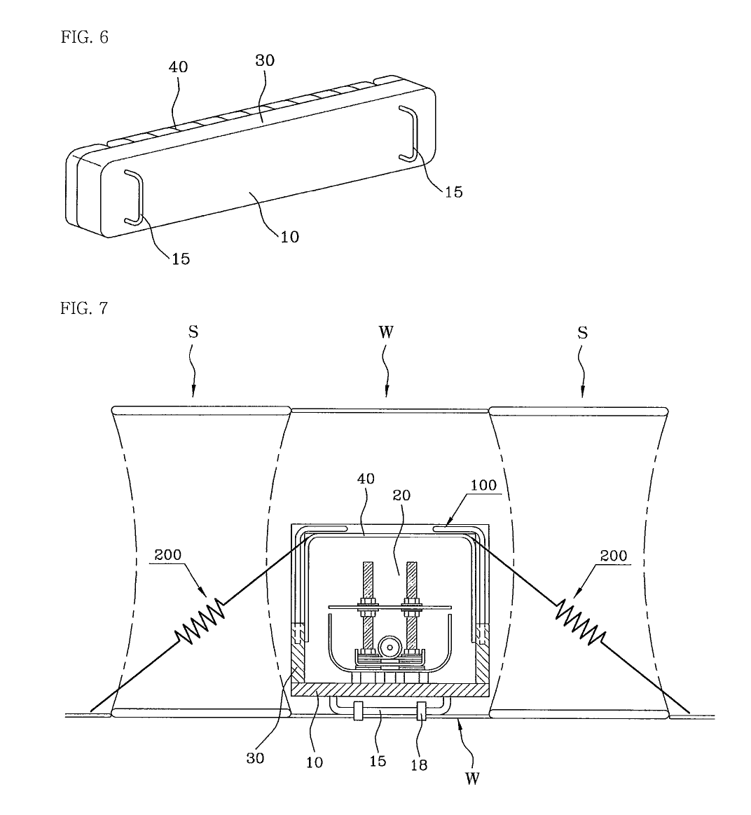

Reference will now be made to the accompanying drawings, wherein FIG. 3 is a view illustrating a built-in heating device for a bed mattress according to an embodiment of the present invention, FIG. 4 is a view illustrating a built-in heating device for a bed mattress according to another embodiment of the present invention, FIGS. 5A to 5C are views illustrating various kinds of support members which are provided in the heating device, FIG. 6 is a perspective view illustrating an undersurface of a base plate of the heating device, and FIG. 7 is a view illustrating the installation structure of the built-in heating device for a bed mattress according to the present invention.

As illustrated in FIGS. 3 and 4, a built-in heating device for a bed mattress includes a base plate 10, a heater 20 coupled with an upper surface of the base plate 10 such that the heater 20 is spaced apart from the base plate 10, a side member 30 formed along an upper edge of the base plate 10 without coming into contact with the heater 20, a net-type protection cover 40 coupled with an upper portion of the side member 30, and a support means for supporting the protection cover 40 from being pushed down owing to the pressure applied onto the upper surface of the protection cover 40.

Particularly, the support means may be a plurality of support members 100, which is coupled to an upper portion of a side of the side member 30 while being bent into the shape of a [symbol] (in a side view) and separated from the upper surface of the protection cover 40.

In detail, the support member 100 is a [symbol] type planar member having a plurality of holes 110 as illustrated in FIG. 5A.

The holes 110 of the planar, bent support member are provided in horizontal and vertical planes in order to allow heat from the protection cover 40 to smoothly dissipate therethrough. Further, as illustrated in FIG. 5A, ends of the sides of the vertical plane of the [symbol] type bent portion preferably are of the shape of a shaft or rod such that they are easily coupled with the upper portion of the side of the side member 30.

Meanwhile, as illustrated in FIGS. 5B and 5C, the support member 100 may be configured such that two [symbol] type bent shafts 120 are provided in parallel with the respective ends connected with each other. Such a support member may be obtained by bending a single rod (shaft) having a rectangular or circular section.

Further, a stop ring 130 may preferably be further provided between the support member 100 and the upper portion of the side of the side member 30 for mutual firm coupling. The stop ring (such as a push nut) may be a commonly used mechanical fixing element, which is forcedly inserted into the groove-less shaft (axis) destined to be coupled, so as to fix it.

Further, a projection fitting 35, which is provided on an outer surface of a side of the side member 30 as illustrated in FIG. 4, is a width-extension of an engaging portion (an upper portion of a side) of the side member 30 for the firm coupling and stable supporting of the support member 100.

Owing to the protection fitting 35, the upper portions of both sides of the side member 30 are not required to be wide in a width direction along the whole length, so that the entire size and weight of the heating device can preferably be effectively reduced.

FIG. 7 is a view taken along line A-A of FIG. 3 and illustrates the installation structure of the built-in heating device for a conventional bed mattress according to the present invention. In the mattress, a plurality of bed springs s is arranged such that they are respectively connected by a wire w.

One or more heating devices of the invention are built in the conventional mattress. The heating device may be installed in space between the bed springs s as illustrated in FIG. 7. In this case, the entire volume, such as the width, height or the like, of the heating device should be taken into consideration.

When the heating device is installed in the space between the bed springs s as illustrated in FIG. 7, if a user lies on the mattress or pressure is applied onto the upper surface of the mattress, the bed springs s are compressed in a vertical direction, so that the wire w or the bed springs s become closer to the upper surface of the protection cover 40 of the heating device. In this case, the support member 100, which was separated from the upper surface and side of the protection cover 40, serves to protect the heating device from the downward pressure (which was applied downwards from the upper surface of the mattress).

Meanwhile, as illustrated in FIG. 6, one or more hooks 15 are provided on an undersurface of the base plate 10 in order to, when the heating device is fixedly installed on the base of the mattress as illustrated in FIG. 7, engage the base plate-wire w or the like using a C-ring 18.

The C-ring is a coupling member generally called a C-pin or a hogged-ring pin, which is a circular loop with a portion opened. Such a C-ring 18 can simply bind two or more objective articles using a binder in a type of a gun, generally.

Further, as illustrated in FIG. 7, a plurality of tensioners 200 may preferably be provided such that one set of ends thereof is installed on both sides of the heating device, and the other set of ends thereof is engaged with the wire w or the bed spring s, which is provided on the base plate of the mattress, so as to stably support the heating device. The tensioner may be of any shape or type, but may implement an elastic support such that it expands and contracts in a longitudinal direction.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A built-in heating device for a bed mattress comprising: a base plate; a heater coupled with an upper surface of the base plate such that the heater is spaced apart from the base plate; a side member formed along an upper edge of the base plate without coming into contact with the heater, and a net-type protection cover coupled with an upper portion of the side member,
wherein a plurality of support members is coupled to an upper portion of a side of the side member while being bent into a shape of [symbol] as seen in a side view and separated from an upper surface of the protection cover, so as to, when the heating device is installed between bed springs in the bed mattress and pressure is applied onto the upper surface of the protection cover, prevent the protection cover from being damaged.

2. The built-in heating device according to claim 1, wherein each of the plurality of support members is a [symbol] type planar member having a plurality of holes.

3. The built-in heating device according to claim 1, wherein the support member includes two [symbol] type bent shafts with two bent ends connected with each other, and wherein a stop ring is further provided between the support member and the upper portion of the side of the side member for mutual firm coupling.

4. The built-in heating device according to claim 2, wherein one or more hooks are provided on an undersurface of the base plate in order to, when the heating device is fixedly installed on the base of the mattress, engage the base plate using a C-ring.

5. The built-in heating device according to claim 2, wherein a plurality of tensioners is provided such that one set of ends thereof is installed on both sides of the heating device, and the other set of ends thereof is engaged with a wire or the bed spring, which is provided on the base plate of the mattress, so as to stably support the heating device.

6. The built-in heating device according to claim 3, wherein one or more hooks are provided on an undersurface of the base plate in order to, when the heating device is fixedly installed on the base of the mattress, engage the base plate using a C-ring.

7. The built-in heating device according to claim 3, wherein a plurality of tensioners is provided such that one set of ends thereof is installed on both sides of the heating device, and the other set of ends thereof is engaged with a wire or the bed spring, which is provided on the base plate of the mattress, so as to stably support the heating device.
